(19) United States
(12) Patent Application Publication
(10) Pub. No.: US 2007/0137192 A1
(43) Pub. Date: Jun. 21, 2007

(54) Circuit arrangement

(76) Inventors: Gerd Anton Thiry, Wadgassen (DE); Alois Hoffmann, Saarbrucken (DE); Harald Bar, Puttlingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/580,197

(22) PCT Filed: Dec. 8, 2004
(86) PCT No.: PCT/EP04/13927

§ 371 Date: May 23, 2006

(30) Foreign Application Priority Data
Feb. 5, 2004 (DE) 10 2004 005 606.4

(51) Int. Cl. F16D 31/02

(52) U.S. Cl. 60/466

(57) ABSTRACT

The invention relates to a circuit arrangement comprising a load sensing system (LS) wherein individual loads (10,14) are arranged in series, forming a series section, and in parallel, forming a parallel section, in a hydraulic supply circuit (12) comprising at least one supply pump (P) and a runback (16) for fluid, the load sensing system (LS) determining the highest load pressure in both the series section and parallel section. The loads of the parallel section can be actuated independently from the pressure level of the loads of the series section due to the fact that the respectively highest load pressure is transferred as a control pressure to a valve unit (18) in such a way that, as long as the load pressure of the parallel section is higher than the load pressure of the series section, the valve unit restricts the runback (16) for fluid so much that the pressure of the supply pump (P) matches or exceeds the pressure required in the parallel section. In this way, a sufficient fluid pressure for the respective load in the parallel section is ensured independently of the number of loads in the series section.

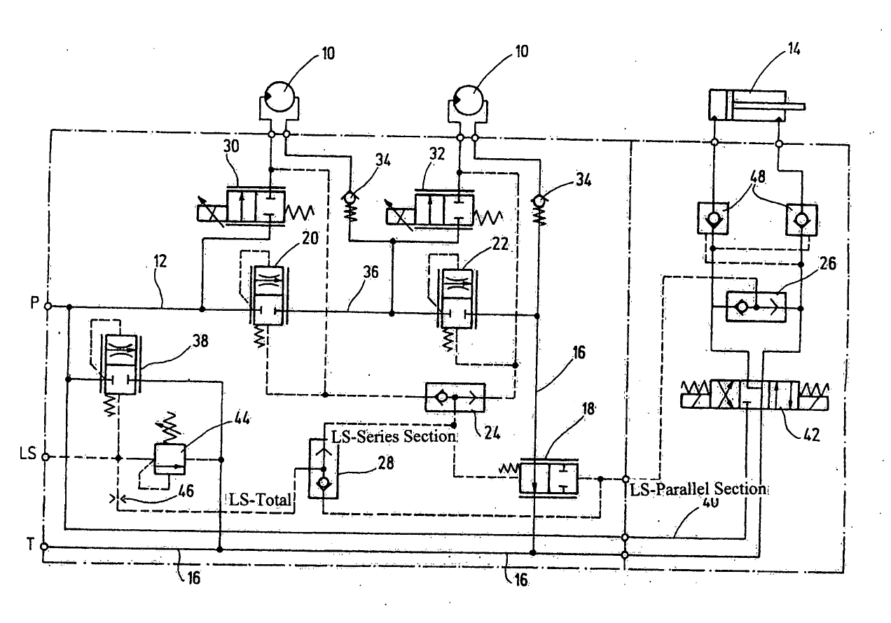

The invention relates to a circuit arrangement with a load sensing system in which individual consumers arranged both in series with formation of a series section and also in parallel with formation of a parallel section to one another are connected to a hydraulic supply circuit with at least one supply pump and a fluid return, the load sensing system determining the highest load pressure at the time for the series and parallel section.

A synonym for a load sensing system is the concept of a load pressure reporting system, the indicated system being a hydraulic control system with pressure and volumetric flow matching, specifically to the instantaneous requirements of one or more consumers. These load sensing systems which are commercially common can be implemented both with a fixed displacement pump and also with an adjustable displacement pump.

Furthermore, in hydraulic systems and controls the respective consumers can be arranged fundamentally in series and/or parallel to one another in the supply circuit.

In a conventional series connection, the same liquid stream flows through the consumers and the pressures are added to one another. The return of one consumer forms the inflow of the next consumer so that the entire volumetric flow is available to each consumer in succession. The series connection is used especially wherever consumers with low load pressures are present.

The velocity of the consumers is controlled independently of the load pressure preferably via proportional flow regulators consisting of a proportional choke valve and a bypass manometric balance. In this arrangement the velocities of the two consumers can be set independently of one another, which is a good idea for a plurality of applications.

Consumers connected in parallel conversely are all subject to the same input pressure and volumetric flows. In order to operate all consumers at the same time with maximum velocity, the supply pump must then be dimensioned to be correspondingly large, which is not necessary in a series connection, as shown.

In a load sensing system of the indicated type, the highest load pressure is determined and the pump pressure is raised by a certain amount over this load pressure, for example by means of a circulation manometric balance. In a system which consists of a combination of parallel and the above described series connection however a pressure higher than is necessary for the series connection section cannot build up, since there the excess fluid (oil) is routed to the tank via the bypass manometric balances. This is especially undesirable when higher pressures are needed in the parallel section, for example to be able in this way to ensure operation of a machine and its parts.

Proceeding from this prior art, the object of the invention is to further improve the known circuit arrangements with a load sensing system while maintaining the advantages, such that the consumers of the parallel section can be actuated independently of the pressure level of the consumers of the series section and that higher pressures are available if they are required in the parallel section for the consumers there. This object is achieved by a circuit arrangement with the features of claim 1 in its entirety.

Because according to the characterizing part of claim 1 the load pressure which is highest at the time is relayed as the control pressure to a valve unit such that if the load pressure of the parallel section is higher than the load pressure of the series section, the valve unit dramatically chokes the return for fluid until the pressure of the supply pump rises to or over the pressure required in the parallel section, it is ensured that the consumers of the parallel section can be actuated independently of the pressure level of the consumers of the series section. In this respect it is also possible to ensure enough fluid pressure for the respective consumer in the parallel section regardless of the number of consumers in the series section. This circuit arrangement works in an energy-saving manner, since the pump pressure is always raised depending on the load pressure only to the extent necessary.

In one preferred embodiment of the circuit arrangement as claimed in the invention, the valve unit is formed from a hydraulically controllable proportional slide valve, preferably a 2-way proportional slide valve. Based on the proportional slide valve it is possible to raise the pump pressure of the supply pump only to the extent necessary, which benefits the energy-saving operation of the overall system and thus the circuit arrangement.

In another preferred embodiment of the circuit arrangement as claimed in the invention, between the supply pump and the return a circulation manometric balance is connected to the supply circuit on which the highest load pressure altogether prevails. If thus a consumer is not active or required, the fluid (oil) with the low pressure loss can be returned via the circulation manometric balance to the tank, which in turn benefits an energy-saving operation.

Other advantageous embodiments are the subject matter of the other dependent claims.

The circuit as claimed in the invention is detailed below using one exemplary embodiment according to the drawing. Here the sole figure is drawn in the form of a circuit diagram shows the important components of the circuit arrangement as claimed in the invention.

The circuit arrangement as claimed in the invention is equipped with a load sensing system which is labeled LS in the circuit diagram. The circuit arrangement is furthermore characterized in that individual consumers 10 are arranged in succession as series consumers of a series section in the direction of fluid flow. In addition to the series consumers 10 and parallel to them and with the formation of a parallel section, a parallel consumer 14 is connected to the hydraulic supply circuit 12. The series consumers 10 are formed from individual hydraulic motors and the parallel consumer 14 is formed from a conventional hydraulically operating working cylinder. The indicated hydraulic supply circuit 12 discharges on its free ends into a supply pump P and into a tank T. The line of the supply circuit 12 connected to the tank T forms the return 16 of the circuit arrangement.

By means of the load sensing system LS it is possible to determine the load pressure which is highest at the time for the series section and for the parallel section as is shown in the circuit diagram by LS-Series and LS-Parallel. The respectively highest load pressure, whether from the series or parallel section, is relayed as control pressure to the valve unit 18 for its triggering. If then for example the load pressure of the parallel section with the parallel consumers 14 is higher than the load pressure of the series section with the series consumers 10, the valve unit 18 relative to the return 16 for fluid is dramatically choked until the pressure of the supply pump P rises to or over the pressure required in the parallel section for this consumer 14. Thus it is possible to actuate and trigger the parallel consumer 14 independently of the pressure level or the series consumers 10 in a manner which was not possible with the existing circuit arrangements with a load sensing system.

The series or parallel section consists at least of one consumer 10, 14, preferably two series-connected consumers 10 of the series section being located in the fluid flow direction in front of the parallel section with a parallel consumer 14. But other consumer configurations are also conceivable here, for example, only one consumer 10 for the series section and two or more consumers for the parallel section (not shown). The aforementioned valve unit 18 which processes the control pressures of the load sensing system consists of a hydraulically controllable proportional slide valve, preferably of a 2-way proportional slide valve. Furthermore, a bypass manometric balance 20, 22 is assigned to each consumer 10 of the series section.

One control pressure line for the valve unit 18 is connected to a shuttle valve 24 of the series section and the other control pressure line is connected to the shuttle valve 26 of the parallel section and to the shuttle valve 28 of the load sensing system LS. How the interconnection is done in particular follows directly from the circuit arrangement as shown in the circuit diagram figure. Furthermore, the control inputs of the respective bypass manometric balances 20, 22 of the series section are each connected to the output of the shuttle valve 24 assigned to the series section. As furthermore follows from the circuit diagram, the output of the manometric balance 20 is connected to the input of the manometric balance 22 to carry fluid and the output of the manometric balance 22 discharges into the return line 16 which is connected on the input side to the valve unit 18.

In the fluid flow direction upstream from the manometric balance 20, in a branch to the series section the connection of the first consumer 10 to the supply circuit 12 takes place, and the pertinent supply can be blocked via a proportional choke valve 30. The output of the consumer 10 which is first in series discharges onto the input side of another proportional choke valve 32 to which the second consumer 10 is connected on the output side. The respective output of the consumer 10 is protected via a non-return valve 34. Furthermore, the input of the proportional choke valve 32 is connected to carry fluid to the connecting line 36 between the two manometric balances 20, 22. The prevailing fluid pressure on the output side of the two proportional choke valves 30, 32 is routed as control pressure both to one side of the manometric balances 20, 22 and also to the shuttle valve 24. On the opposing side of the manometric balances 20, 22 the input-side fluid pressure as control pressure prevails on the indicated manometric balances 20, 22.

Between the supply pump P and the return 16, a circulation manometric balance 38 is connected to the supply circuit 12. The control pressures for this circulation manometric balance 38 are in turn formed on one side by way of the load sensing system LS and on the other side by way of the input pressure on the manometric balance 38 itself The output of the manometric balance 38 is connected to the return 16 to carry fluid and the input side is connected to the supply pump P. This pump supply pressure is also present at the input of a 4/3 way valve 42 by way of the line 40. The load sensing system LS is secured via a pressure limiting valve 44 and is connected via a choke or diaphragm 46 to the LS-Total Side of the shuttle valve 28.

The output side of the 4/3-way valve 42 discharges in two parallel strands into the shuttle valve 26 and into two nonreturn valves 48 which can be mutually deblocked and which are connected on the output side in turn to the piston and rod space of the working cylinder as parallel consumer 14.

With the valve arrangement as claimed in the invention with a load sensing system, the consumers 10, 14 are located both in series and also parallel to one another. As shown, all series consumers 10 are equipped with a bypass manometric balance 20, 22. The load pressure which is the highest at the time in the series section and in the parallel section are determined separately from one another and are reported as control pressures, as described, to a hydraulically controlled 2-way proportional slide valve 18. If the pressure of the parallel consumers 14 is above that of the series consumer 10, this valve 18 dramatically chokes the return 16 of the series section until the pump pressure of the supply pump P rises above the pressure required in the parallel section. The altogether highest load pressure is always present on the circulation manometric balance 38 in this case. The indicated circuit arrangement works in an energy-saving manner, since the pump pressure is always raised depending on the load pressure only as much as necessary. In summary the advantages can be described as follows.
Parallel consumers 14 can be actuated independently of the pressure level of the series consumers 10,
the pump pressure of the supply pump P is only raised as far as necessary by the 2-way proportional slide valve 18,
if a consumer 10, 14 is not active, the fluid is routed with a low pressure loss to the tank T by way of the circulation manometric balance 38.

1. A circuit arrangement with a load sensing system (LS) in which individual consumers (10, 14) arranged both in series with formation of a series section and also in parallel with formation of a parallel section to one another are connected to a hydraulic supply circuit (12) with at least one supply pump (P) and a fluid return (16), the load sensing system (LS) determining the highest load pressure at the time for the series and parallel section, characterized in that the load pressure which is highest at the time is relayed as the control pressure to a valve unit (18) such that if the load pressure of the parallel section is higher than the load pressure of the series section, the valve unit dramatically chokes the return (16) for fluid until the pressure of the supply pump (P) rises to or over the pressure required in the parallel section.

2. The circuit arrangement as claimed in claim 1, wherein the series or parallel section consists at least of one consumer (10, 14) and wherein preferably two series-connected consumers (10) of the series section are located in the fluid flow direction in front of the parallel section with a parallel consumer (14).

3. The circuit arrangement as claimed in claim 1, wherein the valve unit (18) is formed from a hydraulically controllable proportional slide valve, preferably a 2-way proportional slide valve.

4. The circuit arrangement as claimed in one of claims 1, wherein a bypass manometric balance (20, 22) is assigned to each consumer (10) of the series section.

5. The circuit arrangement as claimed in one of claims 1, wherein one control pressure line for the valve unit (18) is connected to a shuttle valve (24) of the series section and the other control pressure line is connected to at least one shuttle valve (26) of the parallel section and to at least one shuttle valve (28) of the load sensing system (LS).

6. The circuit arrangement as claimed in claim 4, wherein the control inputs of the respective bypass manometric balances (20, 22) of the series section are each connected to the output of the shuttle valve (24) assigned to the series section.

7. The circuit arrangement as claimed in claim 1, wherein between the supply pump (P) and the return (16) a circulation manometric balance (38) is connected to the supply circuit (12) on which the highest load pressure altogether prevails.

8. The circuit arrangement as claimed in claim 1, wherein there is a proportional choke valve (30) between the consumer (10) of the series section which is the first in the fluid flow direction and the supply pump (P), as well as another proportional choke valve (32) between the respectively preceding and the respectively following consumer (10) of a series section.

9. The circuit arrangement as claimed in claim 5, wherein between the shuttle valve (26) of the parallel section and the assigned consumer (14) there are mutually deblockable nonreturn valves (48).

10. The circuit arrangement as claimed in claim 1, wherein the respective consumer (10) of the series section is a hydraulic motor and the consumer (14) of the parallel section is a hydraulic working cylinder.
